(19) United States
(12) Patent Application Publication
(10) Pub. No.: US 2014/0368302 A1
(43) Pub. Date: Dec. 18, 2014

(54) RELAY CONTACT SYSTEM

(71) Applicants: SHANGHAI WANJIA PRECISION COMPONENTS CO.,LTD, Shanghai (CN); DONGGUAN SANYOU ELECTRICAL APPLIANCES CO.,LTD, Dongguan (CN)

(72) Inventor: Chao-Yang SONG, Dongguan (CN)

(73) Assignees: SHANGHAI WANJIA PRECISION COMPONENTS CO.,LTD, Shanghai (CN); DONGGUAN SANYOU ELECTRICAL APPLIANCES CO.,LTD, Dongguan (CN)

(21) Appl. No.: 13/960,989

(22) Filed: Aug. 7, 2013

(30) Foreign Application Priority Data
Jun. 14, 2013 (CN) 201310235197.2

(51) Int. Cl. H01H 50/54

(52) U.S. Cl. CPC H01H 50/54
USPC 335/196

(57) ABSTRACT

A relay contact system includes a first conductive plate, a first resilient plate, a second conductive plate and a second resilient plate. One end of the first conductive plate is a free end, and another opposing end is a connecting end. One end of the first resilient plate is a free end provided with a first contact, and another opposing end is a connecting end. The connecting ends of the first conductive plate and the first resilient plate are connected together. The free ends of the first conductive plate and the first resilient plate are arranged in the same direction and form a first zigzag configuration. The second conductive plate and the second resilient plate having a second contact on its free end and form a second zigzag configuration. The first and second zigzag configurations are connected or disconnected through the first and second contacts.

The current application claims a foreign priority to the patent application of China No. 201310235197.2 filed on Jun. 14, 2013.

### BACKGROUND OF THE INVENTION

1. Field of the Invention

The present invention relates to a relay contact system, and more particularly to a relay contact system able to resist the electro-dynamic repulsion force between two contacts.

2. Description of the Prior Art

A relay has a contact system with two contacts. The connection and disconnection of the circuit is controlled by the two contacts to connect with or disconnect from each other. When the two contacts are in contact with each other, is the circuit is connected instantly. The two contacts bear great short current to form an electro-dynamic repulsion force to disconnect the two contacts. The more the short current is, the more the electro-dynamic repulsion force will be so the reliability of the connection of the two contacts is less. When the contact closing force supplied by the resilient plates or the electromagnetic system is not enough to resist the electro-dynamic repulsion force between the contacts, the two contacts will disconnect shortly to cause a rebounding phenomenon of the contacts and a strong electric arc. The instant high temperature generated by the strong electric arc may fuse or burn the contacts easily. Therefore, the electro-dynamic repulsion force between the contacts not only lowers the reliability of the relay but also burn the contacts of the relay to cause a great damage.

Accordingly, the inventor of the present invention has devoted himself based on his many years of practical experiences to solve these problems.

### SUMMARY OF THE INVENTION

The primary object of the present invention is to provide a relay contact system able to resist the electro-dynamic repulsion force between the contacts so that the relay having the contact system can prevent the electro-dynamic repulsion force from damaging.

In order to achieve the aforesaid object, the relay contact system comprises a first conductive plate, a first resilient plate, a second conductive plate and a second resilient plate. One end of the first conductive plate is a free end, and another opposing end of the first conductive plate is a connecting end. One end of the first resilient plate is a free end provided with a first contact, and another opposing end of the first resilient plate is a connecting end. The connecting ends of the first conductive plate and the first resilient plate are connected together. The free ends of the first conductive plate and the first resilient plate are arranged in the same direction and form a first zigzag configuration having a gap defined therebetween. is One end of the second conductive plate is a free end, and another opposing end of the second conductive plate is a connecting end. One end of the second resilient plate is a free end provided with a second contact, and another opposing end of the second resilient plate is a connecting end. The connecting ends of the second conductive plate and the second resilient plate are connected together. The free ends of the second conductive plate and the second resilient plate are arranged in the same direction and form a second zigzag configuration having a gap defined therebetween. The first and second zigzag configurations are connected or disconnected through the first contact and the second contact.

According to the relay contact system of the above-mentioned structure, when the first contact and the second contact are in contact with each other to conduct electricity, the first conductive plate and the first resilient plate have currents flowing in opposite directions and the second conductive plate and the second resilient plate have currents flowing in opposite directions. According to the principle of Lorentz force that the current flowing in opposite directions will generate a repulsion, the first contact on the first resilient plate gets the repulsive Lorentz force from the first conductive plate and the second contact on the second resilient plate gets the repulsive Lorentz force from the second conductive plate so that the first contact and the second contact are in contact with each other firmly. The more the current is, the more the Lorentz force will be. In this way, the two contacts are in contact with each other firm to resist the electro-dynamic repulsion force between the two contacts.

Furthermore, when the first contact and the second contact are in contact with each other to electrify, the electromagnetic repulsion force generated by the currents flowing in opposite directions of the first conductive plate and the first resilient plate of the first zigzag configuration has the same direction as the initial closing force of the first contact applied to the second contact, namely, the electromagnetic repulsion force increases the closing force of the first contact relative to the second contact. Similarly, the electromagnetic repulsion force generated by the currents flowing in opposite directions of the second conductive plate and the second resilient plate of the second zigzag configuration has the is same direction as the initial closing force of the second contact applied to the first contact, namely, the electromagnetic repulsion force increases the closing force of the second contact relative to the first contact.

The initial closing force between the two contacts can be generated by deformation of the first resilient plate and the second resilient plate or by an external force applied to the first resilient plate and the first contact or applied to the second resilient plate and the second contact.

The first resilient plate and the second resilient plate are soft movable conductive members. By applying an external force, the first resilient plate and the second resilient plate can rotate and deform with the connecting end of their respective zigzag configuration as the axle to connect or disconnect the first contact and the second contact.

The first and second zigzag configurations are parallel to each other and arranged in reverse relation to each other, namely, the two contacts are as the originals to form symmetrical originals.

Alternatively, the first and second zigzag configurations are parallel to each other and arranged in the same direction, namely, symmetrical to the X axis or Y axis.

Alternatively, the first and second zigzag configurations are perpendicular to each other, namely, the first resilient plate and the second resilient plate are arranged in perpendicular relation to each other.

The present invention is novel and has a simple structure. By using the Lorentz magnetic force generated by the currents flowing in opposite directions to increase the closing force of the two contacts to resist the electromagnetic repulsion force between two contacts effectively, the reply of the present invention can eliminate the damage caused by the contacts to rebound or burn because of electromagnetic repulsion force.

### BRIEF DESCRIPTION OF THE DRAWINGS

FIG. 1 is a perspective view according to a first embodiment of the present invention;

FIG. 2 is a top view according to the first embodiment of the present invention;

FIG. 3 is a top view according to a second embodiment of the present invention; and

FIG. 4 is a perspective view according to a third embodiment of the present invention.

### DETAILED DESCRIPTION OF THE PREFERRED EMBODIMENTS

Embodiments of the present invention will now be described, by way of example only, with reference to the accompanying drawings.

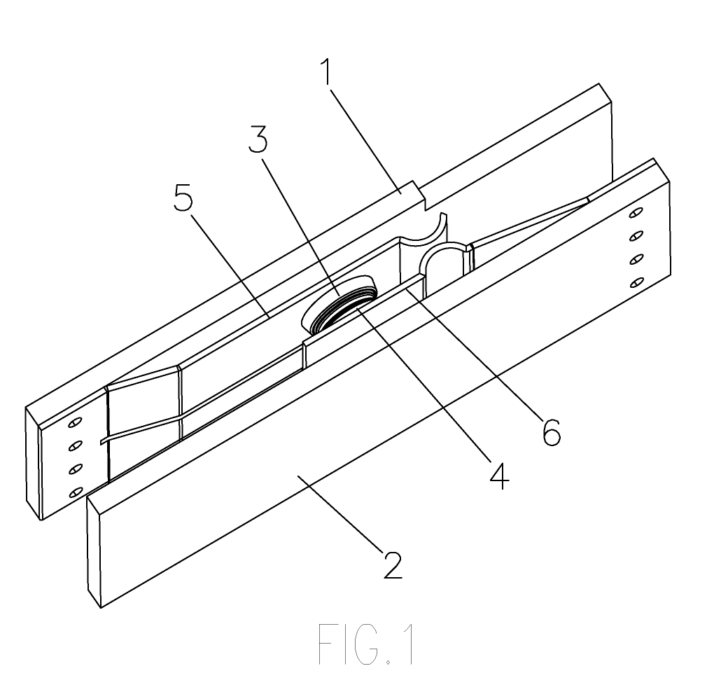

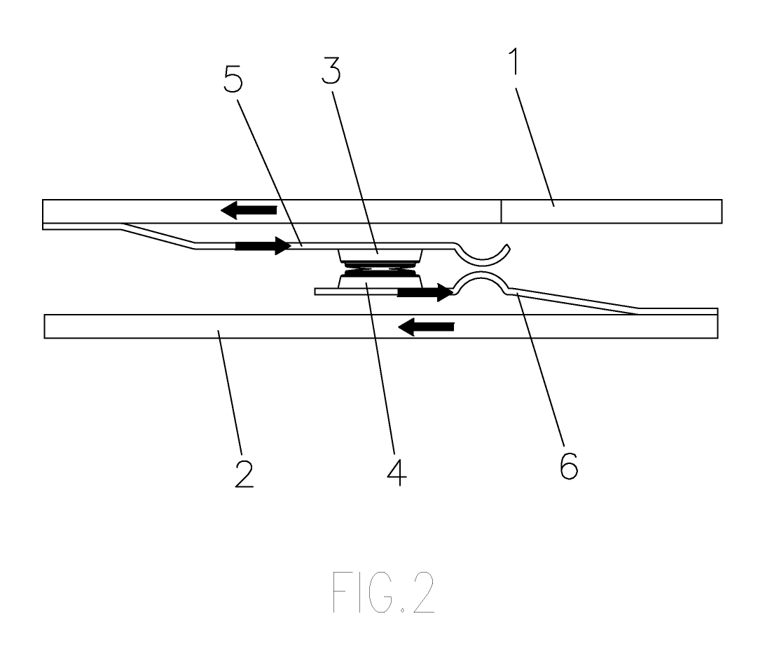

As shown in FIG. 1 and FIG. 2, the relay contact system according to a first embodiment of the present invention comprises a first conductive plate 1, a first resilient plate 5, a second conductive plate 2, and a second resilient plate 6. One end of the first conductive plate 1 is a free end, and another opposing end of the first conductive plate 1 is a connecting end. One end of the first resilient plate 5 is a free end provided with a first contact 3, and another opposing end of the first resilient plate 5 is a connecting end. The connecting ends of the first conductive plate 1 and the first resilient plate 5 are connected together. The free ends of the first conductive plate 1 and the first resilient plate 5 are arranged in the same direction and form a first zigzag configuration having a gap defined therebetween. One end of the second conductive plate 2 is a free end, and another opposing end of the second conductive plate 2 is a connecting end. One end of the second resilient plate 6 is a free end provided with a second contact 4, and another opposing end of the second resilient plate 6 is a connecting end. The connecting ends of the second conductive plate 2 and the second resilient plate 6 are connected together. The free ends of the second conductive plate 2 and the second resilient plate 6 are arranged in the same direction and form a second zigzag configuration having a gap defined therebetween. The first and second zigzag configurations are connected or disconnected through the first contact 3 and is the second contact 4 to form the relay contact system having two zigzag configurations. The first and second zigzag configurations are parallel to each other and arranged in reverse relation to each other, namely, the two contacts 3, 4 are as the original points which are symmetrical.

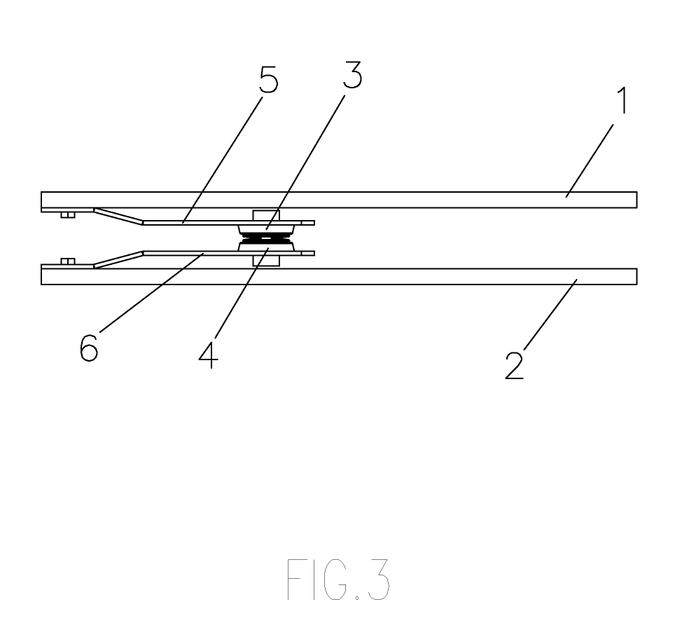

As shown in FIG. 3, the relay contact system according to a second embodiment of the present invention comprises a first conductive plate 1, a first resilient plate 5, a second conductive plate 2, and a second resilient plate 6. One end of the first conductive plate 1 is a free end, and another opposing end of the first conductive plate 1 is a connecting end. One end of the first resilient plate 5 is a free end provided with a first contact 3, and another opposing end of the first resilient plate 5 is a connecting end. The connecting ends of the first conductive plate 1 and the first resilient plate 5 are connected together. The free ends of the first conductive plate 1 and the first resilient plate 5 are arranged in the same direction and form a first zigzag configuration having a gap defined therebetween. One end of the second conductive plate 2 is a free end, and another opposing end of the second conductive plate 2 is a connecting end. One end of the second resilient plate 6 is a free end provided with a second contact 4, and another opposing end of the second resilient plate 6 is a connecting end. The connecting ends of the second conductive plate 2 and the second resilient plate 6 are connected together. The free ends of the second conductive plate 2 and the second resilient plate 6 are arranged in the same direction and form a second zigzag configuration having a gap defined therebetween. The first and second zigzag configurations are connected or disconnected through the first contact 3 and the second contact 4 to form the relay contact system having two zigzag configurations. The first and second zigzag configurations are parallel to each other and arranged in the same direction, namely, symmetrical to the X axis or Y axis.

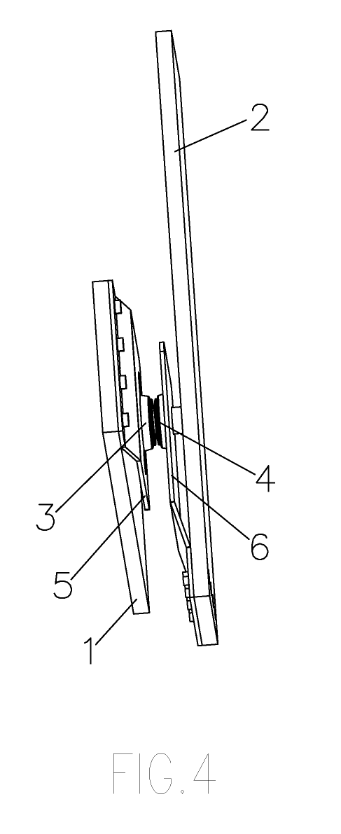

As shown in FIG. 4, the relay contact system according to a third embodiment of the present invention comprises a first conductive plate 1, a first resilient plate 5, a second conductive plate 2, and a second resilient plate 6. One end of the first conductive plate 1 is a free end, and another opposing end of the first conductive plate 1 is a connecting end. One end of the first resilient plate 5 is a free end is provided with a first contact 3, and another opposing end of the first resilient plate 5 is a connecting end. The connecting ends of the first conductive plate 1 and the first resilient plate 5 are connected together. The free ends of the first conductive plate 1 and the first resilient plate 5 are arranged in the same direction and form a first zigzag configuration having a gap defined therebetween. One end of the second conductive plate 2 is a free end, and another opposing end of the second conductive plate 2 is a connecting end. One end of the second resilient plate 6 is a free end provided with a second contact 4, and another opposing end of the second resilient plate 6 is a connecting end. The connecting ends of the second conductive plate 2 and the second resilient plate 6 are connected together. The free ends of the second conductive plate 2 and the second resilient plate 6 are arranged in the same direction and form a second zigzag configuration having a gap defined therebetween. The first and second zigzag configurations are connected or disconnected through the first contact 3 and the second contact 4 to form the relay contact system having two zigzag configurations. The first and second zigzag configurations are perpendicular to each other, namely, the first resilient plate 5 and the second resilient plate 6 are arranged in perpendicular relation to each other.

Although particular embodiments of the present invention have been described in detail for purposes of illustration, various modifications and enhancements may be made without departing from the spirit and scope of the present invention. Accordingly, the present invention is not to be limited except as by the appended claims.

1. A relay contact system, comprising
a first conductive plate;
a first resilient plate;
a second conductive plate;
a second resilient plate;
one end of the first conductive plate being a free end and another opposing end of the first conductive plate being a connecting end;
one end of the first resilient plate being a free end provided with a first contact and another opposing end of the first resilient plate being a connecting end;
the connecting ends of the first conductive plate and the first resilient plate being connected together;
the free ends of the first conductive plate and the first resilient plate being arranged in the same direction and form a first zigzag configuration having a gap defined therebetween;
one end of the second conductive plate being a free end;
another opposing end of the second conductive plate being a connecting end;
one end of the second resilient plate being a free end provided with a second contact and another opposing end of the second resilient plate being a connecting end;
the connecting ends of the second conductive plate and the second resilient plate being connected together;
the free ends of the second conductive plate and the second resilient plate being arranged in the same direction and form a second zigzag configuration having a gap defined therebetween;
the first and second zigzag configurations being connected or disconnected through the first contact and the second contact;
the first and second zigzag configurations are parallel to each other and arranged in reverse relation to each other; and
the two contacts are as original points which are symmetrical.

2. The relay contact system as claimed in claim 1, wherein
when the first contact and the second contact are in contact with each other to electrify, an electromagnetic repulsion force generated by currents flowing in opposite directions of the first conductive plate and the first resilient plate of the first zigzag configuration has the same direction as an initial closing force of the first contact applied to the second contact;
the electromagnetic repulsion force increases the closing force of the first contact relative to the second contact, an electromagnetic repulsion force generated by currents flowing in opposite directions of the second conductive plate and the second resilient plate of the second zigzag configuration has the same direction as an initial closing force of the second contact applied to the first contact; and
the electromagnetic repulsion force increases the closing force of the second contact relative to the first contact.

3. (canceled)

4. A relay contact system, comprising
a first conductive plate;
a first resilient plate;
a second conductive plate;
a second resilient plate;
one end of the first conductive plate being a free end and another opposing end of the first conductive plate being a connecting end;
one end of the first resilient plate being a free end provided with a first contact and another opposing end of the first resilient plate being a connecting end;
the connecting ends of the first conductive plate and the first resilient plate being connected together;
the free ends of the first conductive plate and the first resilient plate being arranged in the same direction and form a first zigzag configuration having a gap defined therebetween;
one end of the second conductive plate being a free end;
another opposing end of the second conductive plate being a connecting end;
one end of the second resilient plate being a free end provided with a second contact and another opposing end of the second resilient plate being a connecting end;
the connecting ends of the second conductive plate and the second resilient plate being connected together;
the free ends of the second conductive plate and the second resilient plate being arranged in the same direction and form a second zigzag configuration having a gap defined therebetween;
the first and second zigzag configurations being connected or disconnected through the first contact and the second contact;
the first and second zigzag configurations are parallel to each other and arranged in the same direction; and
the first and second zigzag configurations are symmetrical to an X axis or a Y axis.

5. A relay contact system, comprising
a first conductive plate;
a first resilient plate;
a second conductive plate;
a second resilient plate;
one end of the first conductive plate being a free end and another opposing end of the first conductive plate being a connecting end;
one end of the first resilient plate being a free end provided with a first contact and another opposing end of the first resilient plate being a connecting end;
the connecting ends of the first conductive plate and the first resilient plate being connected together;
the free ends of the first conductive plate and the first resilient plate being arranged in the same direction and form a first zigzag configuration having a gap defined therebetween;
one end of the second conductive plate being a free end;
another opposing end of the second conductive plate being a connecting end;
one end of the second resilient plate being a free end provided with a second contact and another opposing end of the second resilient plate being a connecting end;
the connecting ends of the second conductive plate and the second resilient plate being connected together;
the free ends of the second conductive plate and the second resilient plate being arranged in the same direction and form a second zigzag configuration having a gap defined therebetween;
the first and second zigzag configurations being connected or disconnected through the first contact and the second contact;
the first and second zigzag configurations are perpendicular to each other; and
the first resilient plate and the second resilient plate are arranged in perpendicular relation to each other.

6. The relay contact system as claimed in claim 4, wherein
when the first contact and the second contact are in contact with each other to electrify, an electromagnetic repulsion force generated by currents flowing in opposite directions of the first conductive plate and the first resilient plate of the first zigzag configuration has the same direction as an initial closing force of the first contact applied to the second contact;
the electromagnetic repulsion force increases the closing force of the first contact relative to the second contact, an electromagnetic repulsion force generated by currents flowing in opposite directions of the second conductive plate and the second resilient plate of the second zigzag configuration has the same direction as an initial closing force of the second contact applied to the first contact; and
the electromagnetic repulsion force increases the closing force of the second contact relative to the first contact.

7. The relay contact system as claimed in claim 5, wherein
when the first contact and the second contact are in contact with each other to electrify, an electromagnetic repulsion force generated by currents flowing in opposite directions of the first conductive plate and the first resilient plate of the first zigzag configuration has the same direction as an initial closing force of the first contact applied to the second contact;
the electromagnetic repulsion force increases the closing force of the first contact relative to the second contact, an electromagnetic repulsion force generated by currents flowing in opposite directions of the second conductive plate and the second resilient plate of the second zigzag configuration has the same direction as an initial closing force of the second contact applied to the first contact; and
the electromagnetic repulsion force increases the closing force of the second contact relative to the first contact.
